(19) United States
(12) Patent Application Publication
(10) Pub. No.: US 2007/0088662 A1
(43) Pub. Date: Apr. 19, 2007

(54) Forum selection in litigation

(76) Inventor: Gregory E. Upchurch, Manchester, MO (US)

Correspondence Address: HUSCH & EPPENBERGER, LLC, 190 CARONDELET PLAZA, SUITE 600, ST. LOUIS, MO, 63105-3441, US

(21) Appl. No.: 11/253,084

(22) Filed: Oct. 18, 2005

(51) Int. Cl. H04K 1/00; G06Q 99/00; H04L 9/00

(52) U.S. Cl. 705/80; 705/1

(57) ABSTRACT

A method of obtaining litigation significant information for venue selection and the like includes identifying a group of active judges to be analyzed, and classifying the outcomes for cases of a predetermined type for those judges.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention relates generally to litigation tools and more specifically to obtaining information useful in evaluating particular venues for litigation and for selecting between or among different venues.

Litigators in the past have studied the available decisions issuing from a particular court to try to determine whether or not that court might be favorable to a client's case. This issue arises, for example, in connection with deciding where to file a case initially and in connection with removal and transfer of a case. This process could be improved. For example, the available decisions often do not represent the most complete available set of information concerning a court or the individual judges. Many outcomes (summary judgment decisions and jury verdicts for example) never are reported anywhere. Using the conventional approach results in a decision on venue that is both incomplete and anecdotal.

The assignee of the present invention has addressed some of these issues in its initial judge reports, which involve analyzing (for a particular judge) all the available dockets for a particular kind of case. The process involves obtaining all the available dockets for the judge and a particular type of suit and classifying each case by outcome (consent judgment, bench trial, summary judgment, etc.). It also involves identifying the prevailing party and the time at which the outcome occurred. This provides, for an individual judge, detailed information concerning win rates (probability of prevailing) broken down by various outcomes, and the time from filing to termination for each outcome.

There are also available historical studies of outcomes by venue (typically by district in federal court or by the particular trial court in state court—whether called a district court, circuit court, etc.). These studies, depending upon the base information used, can be an accurate historical reflection of what has happened in the venue, but are of limited value in predicting how receptive a court might be to a case at present. The assignee of the present application has offered such a product in the past. To applicant's knowledge, these studies have a significant flaw—they include judges who are no longer active (either no longer on the bench or no longer taking cases of the particular type of interest). It turns out that win rates can vary widely from judge to judge (and from district to district), so the fact that a judge is no longer taking cases of a particular type can skew the statistics for an entire district.

### SUMMARY OF THE INVENTION

Among the various objects and features of the present invention are the provision of an improved method of obtaining litigation significant information concerning litigation in a predetermined venue.

A second object is the provision of an improved method of comparing active judges.

A third object is the provision of an improved method of comparing two different venues.

Other objects and features will be in part apparent and in part pointed out hereinafter.

In a first aspect of the present invention, a method of obtaining litigation significant information concerning litigation in a predetermined venue includes the steps of identifying a group of active judges in a predetermined venue, classifying at least some outcomes for each active judge in the group for a particular type of case, and aggregating the classified outcomes to obtain composite outcomes for the group.

In a second aspect of the present invention, a method of comparing active judges in a predetermined venue includes the steps of determining time from filing to final judgment on the merits for each of a group of active judges in a predetermined venue, and comparing the time from filing to final judgment on the merits for each judge in the group.

In a third aspect of the present invention, a method of comparing active judges includes the steps of measuring an experience level of each active judge in a group of active judges in a predetermined type of case, and comparing the measured experience level for each active judge in the group.

In a fourth aspect of the present invention a method of comparing active judges includes the steps of identifying a group of active judges, identifying decisions of a predetermined type of non-dispositive motion for each active judge in the group, aggregating said decisions to obtain aggregated decision information for each active judge in the group, comparing the aggregated decision information for each active judge to the aggregated decision information of the other active judges in the group.

In a fifth aspect of the present invention, a method of obtaining litigation significant information for a predetermined venue includes the steps of identifying decisions on preliminary injunction motions for a group of active judges in a predetermined venue, identifying said decisions that were appealed, determining results of appeals of said appealed decisions, and aggregating the results of said appeals.

In a sixth aspect of the present invention, a method of comparing two different venues includes the steps of identifying a group of active judges in a first venue, identifying a group of active judges in a second venue, classifying at least some outcomes for each active judge in each group for a particular type of case, aggregating the outcomes for each district, and comparing the aggregated outcomes for each district.

### BRIEF DESCRIPTION OF THE DRAWINGS

FIG. 1 is a chart illustrating litigation significant information for a predetermined venue in accordance with the present invention.

FIG. 2 is a chart illustrating the number of terminations on the merits for a particular type of district in a predetermined venue.

FIG. 3 is a chart illustrating a comparison of one type of litigation significant information among judges in a predetermined venue.

FIG. 4 is a chart illustrating various outcomes by type in the predetermined venue.

FIG. 5 is a chart illustrating time from filing to closing for cases of a predetermined type in the predetermined venue.

FIG. 6 is a chart illustrating average pendencies for the predetermined venue for various outcomes.

FIG. 7 is a chart illustrating average time to termination for selected active judges in the predetermined venue for the predetermined type of case.

Similar reference characters indicate similar parts throughout the several views of the drawings.

### DESCRIPTION OF THE PREFERRED EMBODIMENT

A method of the present invention for obtaining litigation significant information concerning litigation in a predetermined venue includes the step of identifying a group of active judges in a predetermined venue. The predetermined venue may include an entire court (such a district in the federal system), or a sub-division of that court (such as a division in the federal system). The active judges are those that are still active in taking the particular type of case of interest. For example, in the federal system senior district judges have considerable discretion over the number and/or types of cases they take. A judge can be considered active for this purpose if he or she has taken a case of the particular type of interest during a predetermined period, such as within the last year or last two years. The period selected is somewhat arbitrary and does not form a part of the present invention. The group of active judges may be all the active judges in the venue, or any subset thereof.

The method also includes classifying at least some outcomes for each active judge in the group for a particular type of case. It is preferred that the outcomes be obtained from a comprehensive source such as the dockets. For courts having a system that makes most documents available electronically, the outcomes could also be obtained from the electronic documents themselves. An outcome, for purposes of this application, is a terminating event such as a consent judgment, a transfer, a judgment entered on a jury verdict, a decision on a dispositive summary judgment motion, a voluntary dismissal, or the like. It does not include decisions which do not dispose of the case. It should be understood, however, that such outcomes are not necessarily the last event in a case. A case can be appealed and return to the venue on remand, for example. An outcome is not a decision on a non-dispositive motion, for purposes of this application. Classifying, as used in this application, means to perform one or more of the following: determining the prevailing party, determining when the outcome occurred, identifying the outcome by type, identifying the terminating event. It should be noted that the step of identifying the active judges may take place before, after, or at the same time as the classifying step.

The present method also includes aggregating the classified outcomes to obtain composite outcomes for the group. Aggregating, as used in this application, can include determining averages, sums, overall venue win rates, and the like, as will become more apparent in the example below. Aggregating can also be done on the time information obtained from classifying, such as the average time to decision in all cases of interest, or the average time to decision on the merits in those cases.

The classified outcomes can be aggregated by judge, and the results for the various judges compared. For example, win rates for the various active judges in the group can be compared, as can the pendency (the average time a case is pending) for each judge for all outcomes or selected outcomes, or other results such as average times to decision on the merits.

Active judges can also be compared in other ways in the context of the present invention. For example, experience levels of each active judge in a group of active judges can be measured for a predetermined type of case, and that measured experience level can then be compared to the other judges in the group. For example, one measure of experience level can be the number of cases of the predetermined type for each active judge in the group. On the other hand, experience levels can be measured, at least in part, by determining the number of cases in which predetermined activity occurred for each active judge in the group. Examples of such predetermined activity could include the filing of a summary judgment motion, or the filing of a preliminary injunction motion.

Although the present invention is particularly suited for using outcomes to obtain litigation significant information, decisions can also be used. In such a situation, the method includes the steps of identifying the group of active judges, identifying decisions of a predetermined type of non-dispositive motion for each active judge in the group, and aggregating the decisions to obtain aggregated decision information for each active judge in the group. The aggregated decision information for each active judge can then be compared to the aggregated decision information of the other active judges in the group. An example would be comparing the win rate on non-dispositive summary judgment motions.

The present invention can also be used to determine how often judges in the group are affirmed or reversed on appeal. This requires classifying not only the outcome, but also the appeal outcome. Such information can be of particular interest in connection with decisions such as preliminary injunction decisions that are appealable without being final. The method in that case involves identifying decisions on preliminary injunction motions for a group of active judges in a predetermined venue, identifying the decisions that were appealed, determining results of appeals of said appealed decisions, and aggregating the results of said appeals from the decisions of the active judges of the group. The success rate on appeal can then be measured in several ways. One takes the number of decisions that were totally affirmed (no remand, reversed in part, etc.) and compares it with the number that were totally reversed (no affirmed in part, etc.). Another compares those decisions affirmed at least in part to those reversed at least in part. Any such comparison can be made as desired.

Although the invention is described herein primarily with respect to active judges of a particular venue, it can readily be used to compare active judges of two or more different venues.

The following example illustrates some of the aspects of the present invention discussed above. To make the discussion concrete it involves a particular venue (in this case the U.S. District Court for the District of Massachusetts) at a particular time (October, 2005). It includes classifying in the conventional way discussed above the dockets of all the active judges in that district as of October, 2005 going back as far as dockets are available. (Shorter time frames could be used.) The particular type of case selected for the example is patent.

During this time period there were 957 total patent cases, of which 860 were closed. Each active judge had 10 to 88 patent cases, with an average of 60 per active judge. Classification also revealed that there were 208 judgments on the merits, with the variation from judge to judge being from 1 to 21 decisions on the merits. The average patentee win rate in these cases was 60%. For judges with at least 10 decisions on the merits, the patentee win rate varied from 37% to 94%. There were 41 trials in these cases, with the number of trials by judge varying from zero to 5. The average time to termination in these cases was 15.1 months, with a variation by judge from 11.0 months to 20.1 months. Similarly, the average time to termination on the merits was 22.4 months, with a variation by judge from 11.2 months to 38.3 months.

There were 299 cases with some summary judgment activity, with variation by judge from 3 cases to 39 cases. There were 114 cases with preliminary injunction activity, with variation from zero cases to 14 cases. There was Markman/claim construction activity in 165 cases (with variation by judge from zero cases to 22 cases). There were 102 appeals, of which 49 were affirmed at least in part and 10 were reversed at least in part.

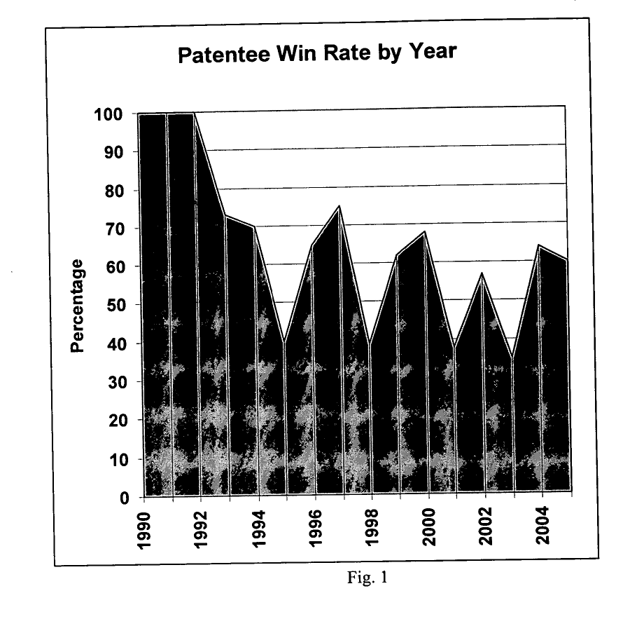

Of the 860 closed patent cases in the District of Massachusetts in the period, 24.2% were terminated on the merits, i.e., by trial, pre-trial motion, default or consent judgment. Patentees won 60% of those cases decided on the merits. FIG. 1 illustrates the patentee win rate by year. The actual numbers of patentee “wins” versus total terminations on the merits from 1990 through 2005 are as follow:

| Year | Patentee Wins | Total Decisions | Patentee Win Rate |
|---|---|---|---|
| 1990 | 1 | 1 | 100 |
| 1991 | 8 | 8 | 100 |
| 1992 | 4 | 4 | 100 |
| 1993 | 8 | 11 | 73 |
| 1994 | 7 | 10 | 70 |
| 1995 | 6 | 15 | 40 |
| 1996 | 11 | 17 | 65 |
| 1997 | 9 | 12 | 75 |
| 1998 | 7 | 18 | 39 |
| 1999 | 8 | 13 | 62 |
| 2000 | 15 | 22 | 68 |
| 2001 | 5 | 13 | 38 |
| 2002 | 13 | 23 | 57 |
| 2003 | 6 | 17 | 35 |
| 2004 | 9 | 14 | 64 |
| 2005 | 6 | 10 | 60 |

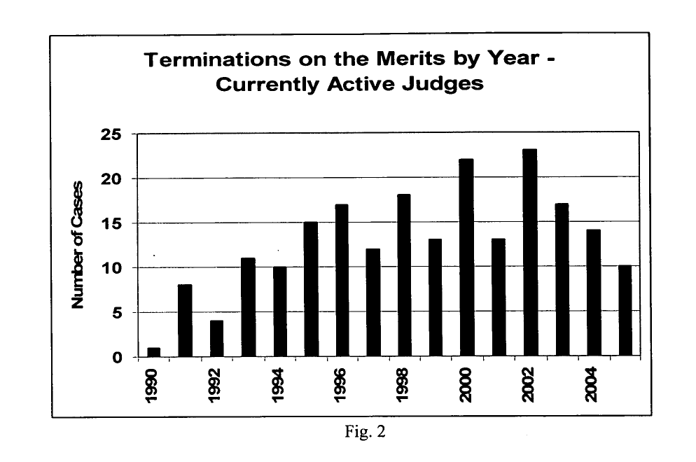

The total number of terminations on the merits per year by the currently active judges during the same period in the District of Massachusetts is shown in FIG. 2.

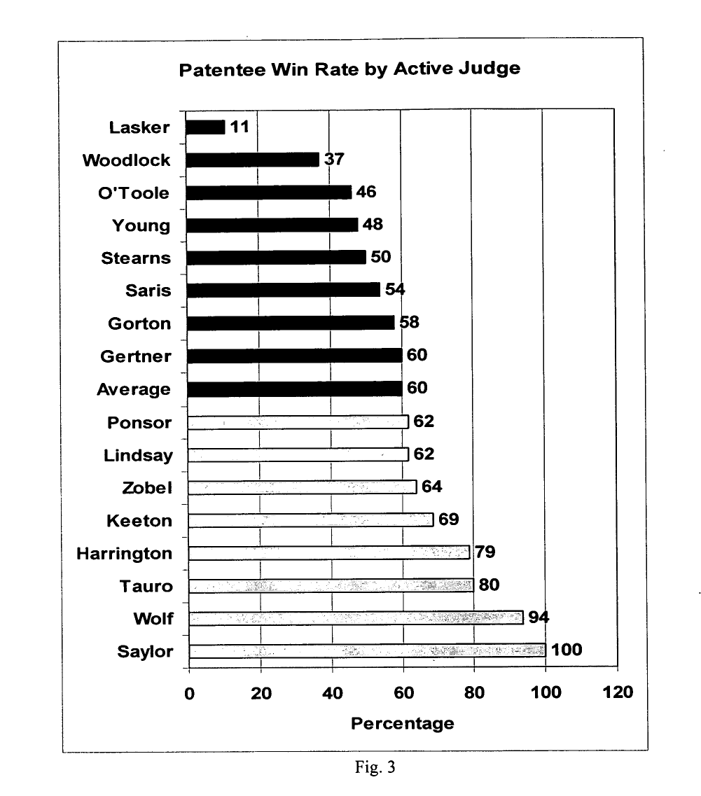

For the district as a whole the patentee win rate for these active judges over this period was 60%. The patentee win rate varies significantly from judge to judge over the period covered by this report—from 11% to 100%. For judges with at least ten terminations on the merits, the range is from 37% to 94%. FIG. 3 illustrates these win rates for those judges with at least 1 termination on the merits. The following table provides the patentee win rate information for each judge with at least 1 termination on the merits, along with the number of terminations on the merits by that judge in patent cases during this period.

| Judge | Number of Decisions on Merits | Patentee Win Rate |
|---|---|---|
| Average for | 13 | 60 |
| the Court | | |
| Gertner | 15 | 60 |
| Gorton | 12 | 58 |
| Harrington | 19 | 79 |
| Keeton | 16 | 69 |
| Lasker | 9 | 11 |
| Lindsay | 8 | 62 |
| O'Toole | 13 | 46 |
| Ponsor | 8 | 62 |
| Saris | 13 | 54 |
| Saylor | 1 | 100 |
| Stearns | 12 | 50 |
| Tauro | 15 | 80 |
| Wolf | 16 | 94 |
| Woodlock | 19 | 37 |
| Young | 21 | 48 |
| Zobel | 11 | 64 |

Of the 860 closed patent cases in the District of Massachusetts during the period covered by this report, 41 were decided at trial. The patentee prevailed in 24 cases and the accused infringer prevailed in 17. The patentee won in 7 bench trials and 17 jury trials. The accused infringer won in 7 bench trials and 10 jury trials. In addition, the defendant prevailed on JMOL after trial in 1 cases. The 17 patentee jury verdicts were before Judges Gertner (1), Gorton (3), Harrington (2), Keeton (1), Lindsay (2), Saris (3), Stearns (1), Young (2), and Zobel (2). The 10 accused infringer jury verdicts were before Judges Gertner (2), Gorton (1), Harrington (1), Keeton (1), Lasker (1), O'Toole (1), Steams (1), Woodlock (1), and Young (1). The 7 bench trial terminations for the patentee were before Judges Gertner (1), Harrington (2), Saris (1), Woodlock (1), and Young (2). The 7 bench trial terminations for the accused infringer were before Judges Gertner (1), Lindsay (1), O'Toole (1), Ponsor (2), Saris (1), and Zobel (1).

There were 100 judgments on the merits in favor of the patentee other than by trial. Patentee prevailed in 83 cases by consent judgment, 8 cases by default judgment, 1 case by involuntary dismissal and 8 cases by summary judgment. There were 67 judgments on the merits in favor of the accused infringer other than by trial. The accused infringer prevailed in 2 cases by consent judgment, 1 case by default judgment, 15 cases by involuntary dismissal, 1 case by judgment as a matter of law, 1 case by other termination and 47 cases by summary judgment.

All the terminations on the merits for the District of Massachusetts during this period are shown in the following table:

| District Terminations | Patentee | | Accused Infringer | |
|---|---|---|---|---|
| At Trial | 59% | (24/41) | 41% | (17/41) |
| Bench Trial | 50% | (7/14) | 50% | (7/14) |
| Jury Verdict | 63% | (17/27) | 37% | (10/27) |
| Consent Judgment¹ | 98% | (83/85) | 2% | (2/85) |
| Default Judgment | 89% | (8/9) | 11% | (1/9) |
| Involuntary Dismissal | 6% | (1/16) | 94% | (15/16) |
| Judgment as a Matter of | 0% | (0/1) | 100% | (1/1) |
| Law | | | | |
| Other Termination | 0% | (0/1) | 100% | (1/1) |
| Summary Judgment | 15% | (8/55) | 85% | (47/55) |
| Overall (on the Merits) | 60% | (124/208) | 40% | (84/208) |

¹Consent judgments are presumed to be in favor of the plaintiff unless the docket indicates otherwise.

Patentees prevailed above the overall average (60%) in cases terminated by jury verdict (63%), consent judgment (98%), and default judgment (89%). Accused infringers prevailed above the overall average (40%) in cases terminated by bench trial (50%), involuntary dismissal (94%), judgment as a matter of law (100%), other termination (100%), and summary judgment (85%).

The 15 involuntary dismissals for the accused infringers were decided by the judges as shown in the following table. Judges omitted from this table had no decisions granting motions to dismiss during the period of time covered.

| Judge | Number of Terminations on Merits | Involuntary Dismissals |
|---|---|---|
| Gertner | 15 | 1 |
| Gorton | 12 | 3 |
| Keeton | 16 | 1 |
| Lasker | 9 | 1 |
| Lindsay | 8 | 1 |
| O'Toole | 13 | 1 |
| Tauro | 15 | 1 |
| Woodlock | 19 | 2 |
| Young | 21 | 5 |

Terminations by summary judgment are not included in these figures.

The 55 summary judgment dispositions were decided as indicated in the table below.

| | Summary | Summary Judgment for Accused |
|---|---|---|
| Judge | Judgement for Patentee | Infringer |
| Gertner | 0 | 1 |
| Gorton | 0 | 1 |
| Harrington | 0 | 2 |
| Keeton | 0 | 3 |
| Lasker | 0 | 6 |
| Lindsay | 1 | 1 |
| O'Toole | 0 | 5 |
| Ponsor | 1 | 1 |
| Saris | 2 | 4 |
| Stearns | 0 | 5 |
| Tauro | 1 | 2 |
| Wolf | 1 | 1 |
| Woodlock | 1 | 8 |
| Young | 1 | 5 |
| Zobel | 0 | 2 |

Of the 860 terminated cases,
3 (0.3%) were terminated by bankruptcy stay, with an average pendency of 18.5 months
85 (9.9%) were terminated by consent judgment, with an average pendency of 12.7 months
22 (2.6%) were terminated by consolidation, with an average pendency of 6.1 months
9 (1.0%) were terminated by default judgment, with an average pendency of 13.2 months
16 (1.9%) were terminated by involuntary dismissal, with an average pendency of 13.0 months
1 (0.1%) was terminated by judgment as a matter of law, with an average pendency of 47.7 months
8 (0.9%) were terminated for lack of jurisdiction, with an average pendency of 16.1 months
41 (4.8%) were terminated by miscellaneous settlement, with an average pendency of 18.9 months
12 (1.4%) were terminated by other miscellaneous termination, with an average pendency of 11.3 months
1 (0.1%) was terminated by remand to state court, with an average pendency of 2.5 months
12 (1.4%) were terminated by stay, with an average pendency of 9.0 months
55 (6.4%) were terminated by summary judgment, with an average pendency of 26.0 months
29 (3.4%) were terminated by transfer, with an average pendency of 7.7 months
14 (1.6%) were terminated by bench trial, with an average pendency of 47.0 months
27 (3.1%) were terminated by jury trial, with an average pendency of 40.7 months
484 (56.3%) were terminated by voluntary dismissal, with an average pendency of 13.4 months
41 (4.8%) were terminated for want of prosecution, with an average pendency of 7.9 months

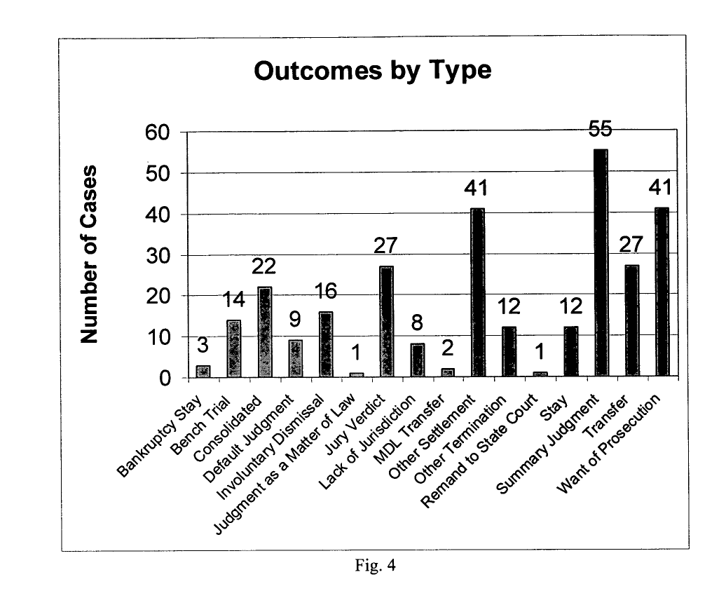

FIG. 4 illustrates the case outcomes for the District of Massachusetts in patent cases. The 85 consent judgments and the 484 voluntary dismissals are excluded from FIG. 4.

For District of Massachusetts as a whole during the period covered by this report, there were 14 bench trials in patent cases. The following table shows which judges had bench trials in these cases and how many bench trials each had.

| Judge | Bench Trials for Patentee | Bench Trials for Accused Infringer |
|---|---|---|
| Gertner | 1 | 1 |
| Harrington | 2 | 0 |
| Lindsay | 0 | 1 |
| O'Toole | 0 | 1 |
| Ponsor | 0 | 2 |
| Saris | 1 | 1 |
| Woodlock | 1 | 0 |
| Young | 2 | 0 |
| Zobel | 0 | 1 |

There were 27 jury trials in these cases. The judges who presided over jury trials in patent cases and the number of jury trials are as follows:

| Judge | Jury Trials for Patentee | Jury Trials for Accused Infringer |
|---|---|---|
| Gertner | 1 | 2 |
| Gorton | 3 | 1 |
| Harrington | 2 | 1 |
| Keeton | 1 | 1 |
| Lasker | 0 | 1 |
| Lindsay | 2 | 0 |
| O'Toole | 0 | 1 |
| Saris | 3 | 0 |
| Stearns | 1 | 1 |
| Woodlock | 0 | 1 |
| Young | 1 | 0 |
| Zobel | 2 | 0 |

There were 27 cases terminated by transfer in patent cases in the District of Massachusetts during the period. The table below shows the number of terminations by transfer for each judge that transferred at least 1 case.

| Judge | Cases Transferred |
|---|---|
| Gertner | 2 |
| Gorton | 3 |
| Harrington | 1 |
| Keeton | 1 |
| Lindsay | 2 |
| O'Toole | 1 |
| Ponsor | 1 |
| Saris | 2 |
| Saylor | 1 |
| Stearns | 1 |
| Tauro | 5 |
| Wolf | 4 |
| Woodlock | 1 |
| Young | 1 |
| Zobel | 1 |

This table does not include MDL Transfers.

Of the 208 cases with an identifiable winner, 41 went to trial. The patentee prevailed in 24 of these cases and the accused infringer prevailed in the other 17 cases.

The cases where the patentees prevailed at trial were:

| Case Number | Judge | Case Name | Resolution |
|---|---|---|---|
| 1:03cv11323 | Saris | Inverness Medical | Jury Verdict |
| | | Switzerland GmbH et al v. | |
| | | Acon Labortories, In | |
| 1:01cv11477 | Harrington | American Superconduc v. | Bench Trial |
| | | MIT | |
| 1:01cv11306 | Lindsay | Exergen Corporation v. | Jury Verdict |
| | | Wal-Mart Stores Inc., et al | |
| 1:01cv10178 | Zobel | Cytologix Corp. v. | Jury Verdict |
| | | Ventana Medical | |
| 1:01cv10165 | Harrington | DePuy Spine, Inc., et al v. | Jury Verdict |
| | | Medtronic Sofamor Da, et | |
| | | al | |
| 1:00cv12234 | Harrington | Freedom Wireless Inc v. | Jury Verdict |
| | | Boston Communication, et | |
| | | al | |
| 4:00cv40188 | Gorton | EMC Corporation v. | Jury Verdict |
| | | Hewlett-Packard Comp, et | |
| | | al | |
| 1:00cv11851 | Zobel | Akamai Technologies, et | Jury Verdict |
| | | al v. Digital Island, Inc, et | |
| | | al | |
| 4:99cv40167 | Gorton | Brine, Inc., et at v. STX, | Jury Verdict |
| | | L.L.C., et al | |
| 1:99cv11362 | Woodlock | Technical Manufactur v. | Bench Trial |
| | | Integrated Dynamics | |
| 1:99cv10826 | Gertner | Soitec S. A., et al v. Silicon | Jury Verdict |
| | | Genesis Corp | |
| 1:98cv12019 | Young | MacNeill Engineering v. | Jury Verdict |
| | | Trisport, Ltd. | |
| 1:98cv11152 | Saris | VLT, Inc., et al v. Unitrode | Jury Verdict |
| | | Corporation | |
| 1:98cv10209 | Saris | Bose Corporation v. JBL | Bench Trial |
| | | Inc., et al | |
| 1:96cv12413 | Lindsay | Zeneca Limited v. | Jury Verdict |
| | | Pharmachemie BV | |
| 1:96cv11025 | Young | Read Corp., The, et al v. | Jury Verdict |
| | | Powerscreen of, et al | |
| 1:93cv11512 | Gertner | Columbia University v. | Bench Trial |
| | | Boehringer Mannheim | |
| 1:92cv12085 | Young | Read Corp., the, et al v. | Bench Trial |
| | | Friday, et al | |
| 1:92cv11127 | Stearns | Exergen Corporation v. | Jury Verdict |
| | | Gentri Controls, et al | |
| 1:91cv40081 | Keeton | Selfix Independent P, et al | Jury Verdict |
| | | v. Victory Button Compa, | |
| | | et al | |
| 4:91cv40079 | Gorton | Bay State Technologi v. | Jury Verdict |
| | | Bowers | |
| 1:90cv10316 | Young | Avco Corp. v. PPG | Jury Verdict |
| | | Industries, Inc., et al | |
| 1:89cv40154 | Young | Rubbermaid Inc v. Tucker | Bench Trial |
| | | Housewares, et al | |
| 1:88cv01814 | Saris | Festo Corp v. Shoketsu | Jury Verdict |
| | | Kinzoku, et al | |
| 1:88cv00210 | Harrington | Atlantic Thermoplast v. | Bench Trial |
| | | Faytex Corp | |

The cases where the accused infringers prevailed at trial were:

| Case Number | Judge | Case Name | Resolution |
|---|---|---|---|
| 1:01cv12048 | O'Toole | Invessys, Inc., et al v. The | Jury Verdict |
| | | McGraw-Hill Cos., et al | |
| 1:01cv10765 | Lasker | Nomos Corporation v. | Jury Verdict |
| | | Zmed, Inc | |
| 1:01cv10029 | Woodlock | Axcelis Technologies v. | Jury Verdict |
| | | Applied Materials | |
| 1:00cv10836 | O'Toole | AGFA Corporation v. Creo | Bench Trial |
| | | Products Inc.,, et al | |
| 1:99cv11398 | Gertner | Sagar v. M.I.T., et al | Bench Trial |
| 1:98cv12019 | Young | MacNeill Engineering v. | Jury Verdict |
| | | Trisport, Ltd. | |
| 1:97cv12416 | Lindsay | In Re: ′639 Patent Litigati, | Bench Trial |
| | | et al v. | |
| 1:96cv11907 | Keeton | Dahod v. Bay Networks, | Jury Verdict |
| | | et al | |
| 1:96cv11025 | Young | Read Corp., The, et al v. | Jury Verdict |
| | | Powerscreen of, et al | |
| 1:95cv12123 | Stearns | Scheller v. Shafmaster, et | Jury Verdict |
| | | al | |
| 1:95cv10923 | Harrington | Gates Formed-Fibre v. | Jury Verdict |
| | | Delaware Valley Corp, et | |
| | | al | |
| 4:94cv40200 | Gorton | Neles-Jamesbury, Inc, et | Jury Verdict |
| | | al v. Fisher Service Co. | |
| 1:93cv12237 | Saris | Perseptive Biosystem, et | Bench Trial |
| | | al v. Pharmacia Biotech, | |
| | | et al | |
| 1:92cv12640 | Zobel | Candela Laser Corp. v. | Bench Trial |
| | | Cynosure, Inc., et al | |
| 1:92cv10386 | Gertner | Deknatel Technology, et | Jury Verdict |
| | | al v. Atrium Medical Corp. | |
| 3:91cv13292 | Ponsor | Gentry Gallery v. Berkline | Bench Trial |
| | | Corporation | |
| 1:91cv12413 | Gertner | Eisenberg v. Alimed, Inc., | Jury Verdict |
| | | et al | |
| 3:91cv30139 | Ponsor | Fromson v. Anitec | Bench Trial |
| | | Printing, et al | |

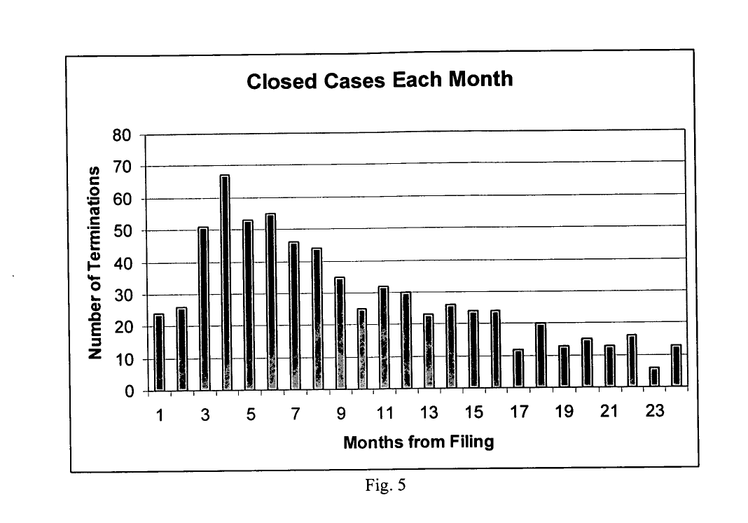

An overview of when terminations typically occur is found in FIG. 5, which shows the number of patent cases in the District of Massachusetts that were terminated per month, for the first two years after filing.

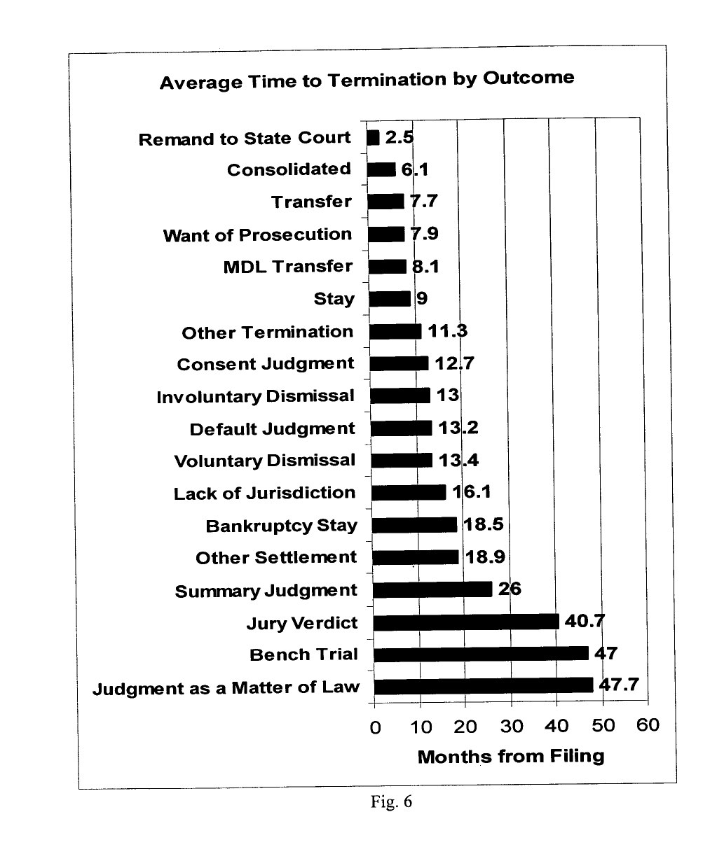

Pendency usually varies by type of termination. For example, transfers typically occur much earlier in litigation than summary judgments. The average case pendency for each type of outcome for patent cases in the District of Massachusetts is shown in FIG. 6.

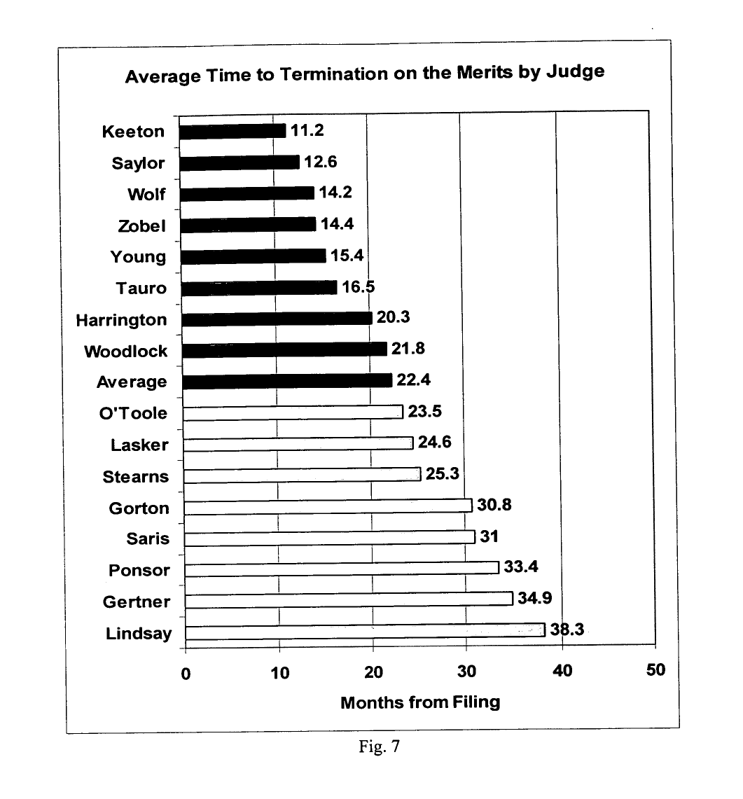

The average time from filing to termination on the merits in these cases was 22.4 months. There is considerable variation of average pendency by judge, ranging from 11.2 months for Judge Keeton to 38.3 months for Judge Lindsay. FIG. 7 shows the variation for average time to termination on the merits by judge.

The average time from filing to termination by bench trial was 47.0 months. For those judges who had at least one patent case with a bench trial during this period, the average time from filing until termination by bench trial varied from 20.8 months for Judge Zobel to 88.9 months for Judge Gertner.

| | | Average Time from Filing to |
|---|---|---|
| | | Termination by Bench Trial |
| Judge | Number of Bench Trials | (Months) |
| Average for the | 0.9 | 47.0 |
| Court | | |
| Gertner | 2 | 88.9 |
| Harrington | 2 | 33.3 |
| Lindsay | 1 | 45.6 |
| O'Toole | 1 | 51.8 |
| Ponsor | 2 | 57.5 |
| Saris | 2 | 36.2 |
| Woodlock | 1 | 57.1 |
| Young | 2 | 25.2 |
| Zobel | 1 | 20.8 |

The average time from filing to termination of patent cases by jury verdict in the District of Massachusetts was 40.7 months. By judge, average time to termination for jury verdicts ranged from 14.3 months for Judge O'Toole to 65.7 months for Judge Gorton. The chart below illustrates the variation among judges.

| | Number | Average Time from Filing to |
|---|---|---|
| Judge | of Jury Trials | Termination by Jury Trial (Months) |
| Average for the | 1.7 | 40.7 |
| Court | | |
| Gertner | 3 | 40.5 |
| Gorton | 4 | 65.7 |
| Harrington | 3 | 46.6 |
| Keeton | 2 | 33.1 |
| Lasker | 1 | 17.2 |
| Lindsay | 2 | 47.6 |
| O'Toole | 1 | 14.3 |
| Saris | 3 | 42.5 |
| Stearns | 2 | 27.7 |
| Woodlock | 1 | 30.4 |
| Young | 3 | 39.8 |
| Zobel | 2 | 24.7 |

The average time from filing to termination by summary judgment in patent cases in the District of Massachusetts was 26.0 months. By judge, average time to termination for summary judgments ranged from 10.0 months for Judge Gertner to 60.3 months for Judge Lindsay. The table below illustrates the variation among judges.

| | Number | Average Time from Filing to |
|---|---|---|
| | of Terminations by | Termination by Summary |
| Judge | Summary Judgment | Judgment (Months) |
| Average for the | 3.4 | 26.0 |
| Court | | |
| Gertner | 1 | 10.0 |
| Gorton | 1 | 19.1 |
| Harrington | 2 | 17.6 |
| Keeton | 3 | 12.5 |
| Lasker | 6 | 26.4 |
| Lindsay | 2 | 60.3 |
| O'Toole | 5 | 37.0 |
| Ponsor | 2 | 35.4 |
| Saris | 6 | 27.7 |
| Stearns | 5 | 33.8 |
| Tauro | 3 | 15.7 |
| Wolf | 2 | 53.5 |
| Woodlock | 9 | 22.7 |
| Young | 6 | 11.9 |
| Zobel | 2 | 14.5 |

The average time from filing to termination by transfer in patent cases in the District of Massachusetts was 7.7 months. By judge, average time to termination for transfers ranged from 1.7 months for Judge Ponsor to 22.7 months for Judge Zobel. The table below illustrates the variation among judges.

| | | Average Time from Filing to |
|---|---|---|
| Judge | Cases Transferred | Transfer (Months) |
| Average for the | 1.7 | 7.7 |
| Court | | |
| Gertner | 2 | 6.1 |
| Gorton | 3 | 12.0 |
| Harrington | 2 | 13.3 |
| Keeton | 1 | 3.5 |
| Lindsay | 2 | 2.4 |
| O'Toole | 1 | 3.7 |
| Ponsor | 1 | 1.7 |
| Saris | 2 | 9.7 |
| Saylor | 1 | 7.5 |
| Stearns | 1 | 4.7 |
| Tauro | 5 | 8.5 |
| Wolf | 4 | 8.4 |
| Woodlock | 1 | 11.2 |
| Young | 1 | 6.4 |
| Zobel | 2 | 22.7 |

Of the 860 closed patent cases in the District of Massachusetts, 102 were appealed. Of those 37 were affirmed; 5 were affirmed in part, reversed in part; 2 were affirmed in part, reversed in part and remanded; 5 were affirmed in part, vacated in part and remanded; 27 were dismissed; 14 are pending; 4 were remanded; 1 was reversed; 2 were reversed in part and remanded; and 5 were vacated in part and remanded. The results of those appeals are shown in the following chart:

| Case Name | Case Number | Judge | Result of Appeal |
|---|---|---|---|
| Akamai Technologies, et al v. Digital | 1:00cv11851 | Zobel | Affirmed in part, Reversed |
| Island, Inc, et al | | | in part and Remanded |
| Dow Corning Wright v. Osteonics | 1:91cv10962 | O'Toole | Affirmed in part, Reversed |
| Corp. | | | in part and Remanded |
| Eisenberg v. Alimed, Inc., et al | 1:91cv12413 | Gertner | Affirmed in part, Reversed |
| | | | in part |
| Read Corp., The, et al v. | 1:96cv11025 | Young | Affirmed in part, Reversed |
| Powerscreen of, et al | | | in part |
| Gentry Gallery v. Berkline | 3:91cv13292 | Ponsor | Affirmed in part, Reversed |
| Corporation | | | in part |
| Fromson v. Anitec Printing, et al | 3:91cv30139 | Ponsor | Affirmed in part, Reversed |
| | | | in part |
| Bay State Technologi v. Bowers | 4:91cv40079 | Gorton | Affirmed in part, Reversed |
| | | | in part |
| Biogen, Inc. v. Schering AG, et al | 1:96cv10916 | Wolf | Affirmed in part, Vacated |
| | | | in part and Remanded |
| Vivid Technologies v. American | 1:96cv11059 | Keeton | Affirmed in part, Vacated |
| Science | | | in part and Remanded |
| Amgen, Inc. v. Hoechst Marion, et al | 1:97cv10814 | Young | Affirmed in part, Vacated |
| | | | in part and Remanded |
| Helifix Limited v. Blok-Lok, LTD., et al | 1:98cv11093 | Keeton | Affirmed in part, Vacated |
| | | | in part and Remanded |
| TurboCare Div. Demag v. General | 3:95cv30069 | Ponsor | Affirmed in part, Vacated |
| Electric Co. | | | in part and Remanded |
| VLT Corporation, et al v. Lucent | 1:00cv11049 | Saris | Affirmed |
| Technologies, et al | | | |
| Schawbel Corporation v. Conair | 1:00cv11112 | Saris | Affirmed |
| Corporation | | | |
| Pieczenik, et al v. Dyax Corporation | 1:00cv11370 | Stearns | Affirmed |
| Okor v. Atari Games Corp., et al | 1:00cv11503 | Woodlock | Affirmed |
| Okor v. Atari Games Corp., et al | 1:00cv11504 | Woodlock | Affirmed |
| Weiss, et al v. USA | 1:00cv12549 | Young | Affirmed |
| VLT Corporation, et al v. Power-One, | 1:01cv10207 | Saris | Affirmed |
| Inc. | | | |
| VLT Corporation, et al v. Artesyn | 1:01cv10238 | Saris | Affirmed |
| Technologies, et al | | | |
| Okor v. Acclaim Entertainmen, et al | 1:01cv10610 | Woodlock | Affirmed |
| VLT, Inc., et al v. Lambda Electronics | 1:01cv10957 | Saris | Affirmed |
| Invessys, Inc., et al v. The McGraw- | 1:01cv12048 | O'Toole | Affirmed |
| Hill Cos., et al | | | |
| Pellegrini v. Analog Devices, Inc | 1:02cv11562 | Zobel | Affirmed |
| Wafer Shave v. Gillette CO | 1:89cv00720 | Wolf | Affirmed |
| Ortho Pharmaceutical, et al v. | 1:91cv12174 | Young | Affirmed |
| Genetics Institute, | | | |
| Exergen Corporation v. Gentri | 1:92cv11127 | Stearns | Affirmed |
| Controls, et al | | | |
| Candela Laser Corp. v. Cynosure, | 1:92cv12640 | Zobel | Affirmed |
| Inc., et al | | | |
| Perseptive Biosystem, et al v. | 1:93cv12237 | Saris | Affirmed |
| Pharmacia Biotech, et al | | | |
| Reebok International, et al v. J. | 1:93cv12645 | Harrington | Affirmed |
| Baker, Inc. | | | |
| The Read Corp., et al v. Viper | 1:94cv10258 | Tauro | Affirmed |
| International, et al | | | |
| ABTOX, Inc., et al v. Exitron | 1:94cv10503 | Lasker | Affirmed |
| Corporation, et al | | | |
| Amgen, Inc. v. Genetics Institute, | 1:94cv11818 | Young | Affirmed |
| Hamilton v. WAHL Clipper Corp,, et | 1:95cv10126 | Harrington | Affirmed |
| al | | | |
| EMC Corporation v. Norand Corp. | 1:95cv10177 | Keeton | Affirmed |
| MHB Industries v. Dennis Garber & | 1:95cv10199 | O'Toole | Affirmed |
| Gates Formed-Fibre v. Delaware | 1:95cv10923 | Harrington | Affirmed |
| Valley Corp, et al | | | |
| Sontek Industries, et al v. Hudson | 1:97cv11223 | Gertner | Affirmed |
| Respiratory | | | |
| In Re: ′639 Patent Litigati, et al v. | 1:97cv12416 | Lindsay | Affirmed |
| Okor v. Sega of America, Inc, et al | 1:97cv12418 | Woodlock | Affirmed |
| Bose Corporation v. JBL Inc., et al | 1:98cv10209 | Saris | Affirmed |
| Okor v. Sega of America, Inc, et al | 1:98cv12176 | Woodlock | Affirmed |
| Okor v. Sony Computer, Inc. | 1:98cv12177 | Woodlock | Affirmed |
| Haemonetics Corp v. Medtronic, Inc. | 1:98cv12227 | Woodlock | Affirmed |
| Summit Technology v. Nidek Co., | 1:98cv12611 | Harrington | Affirmed |
| Ltd., et al | | | |
| AllVoice Computing v. L&H Holdings, | 1:99cv10346 | Woodlock | Affirmed |
| USA,, et al | | | |
| Soitec S. A., et al v. Silicon Genesis | 1:99cv10826 | Gertner | Affirmed |
| Corp | | | |
| Katz v. Lear Siegler, Inc, et al | 3:94cv11869 | Ponsor | Affirmed |
| Neles-Jamesbury, Inc, et al v. Fisher | 4:94cv40200 | Gorton | Affirmed |
| Service Co. | | | |
| BBA Nonwovens v. CMC Magnetics | 1:00cv11536 | Harrington | Dismissed |
| Corp. | | | |
| Boston Scientific Co, et al v. Wilson | 1:00cv40085 | Wolf | Dismissed |
| Cook Medical | | | |
| Axcelis Technologies v. Applied | 1:01cv10029 | Woodlock | Dismissed |
| Materials | | | |
| Nomos Corporation v. Zmed, Inc | 1:01cv10765 | Lasker | Dismissed |
| Kumar, et al v. Ovonic Battery Co., et | 1:01cv11247 | Lasker | Dismissed |
| al | | | |
| Rubbermaid Inc v. Tucker | 1:89cv40154 | Young | Dismissed |
| Housewares, et al | | | |
| Avco Corp. v. PPG Industries, Inc., et | 1:90cv10316 | Young | Dismissed |
| al | | | |
| Conroy v. Reebok International | 1:92cv10593 | Woodlock | Dismissed |
| Radionics, Inc. v. Elekta Instrument | 1:93cv10014 | Zobel | Dismissed |
| AB, et al | | | |
| Prenovitz v. Smith & Nephew Endos | 1:93cv11134 | Keeton | Dismissed |
| Columbia University v. Boehringer | 1:93cv11512 | Gertner | Dismissed |
| Mannheim | | | |
| Hoppe, et al v. Baxter Healthcare | 1:94cv10323 | Keeton | Dismissed |
| Bailey v. Dart Container Corp, et al | 1:94cv10758 | Lindsay | Dismissed |
| Boston Scientific C. v. Scheider | 1:94cv10967 | Woodlock | Dismissed |
| (Europe) AG, et al | | | |
| Minnesota Mining v. Beautone | 1:94cv11156 | Lasker | Dismissed |
| Specialties, et al | | | |
| Ross v. Sonax Furniture, et al | 1:96cv11568 | Stearns | Dismissed |
| Mileti v. Roadway Safety | 1:96cv12158 | Stearns | Dismissed |
| Finnigan Corporation v. Bruker | 1:96cv12568 | Stearns | Dismissed |
| Instruments, et al | | | |
| VLT, Inc., et al v. Unitrode | 1:98cv11152 | Saris | Dismissed |
| Corporation | | | |
| MacNeill Engineering v. Trisport, Ltd. | 1:98cv12019 | Young | Dismissed |
| Bionx Implanis, Inc., et al v. | 1:98cv12111 | Gertner | Dismissed |
| Innovasive Devices | | | |
| Sagar v. M.I.T., et al | 1:99cv11398 | Gertner | Dismissed |
| Respiratory Delivery v. Ferraris | 1:99cv12636 | Lasker | Dismissed |
| Medical, Inc | | | |
| Omniglow Corporation v. Unique | 3:99cv30052 | Ponsor | Dismissed |
| Industries | | | |
| EMC Corporation v. Hewlett-Packard | 4:00cv40188 | Gorton | Dismissed |
| Comp, et al | | | |
| Cabot Safety Int v. Howard S. Leight | 4:96cv40145 | Gorton | Dismissed |
| and | | | |
| Honeywell Consumer v. Windmere | 4:97cv40124 | Gorton | Dismissed |
| Durable, et al | | | |
| Freedom Wireless Inc v. Boston | 1:00cv12234 | Harrington | Pending |
| Communication, et al | | | |
| DePuy Spine, Inc., et al v. Medtronic | 1:01cv10165 | Harrington | Pending |
| Sofamor Da, et al | | | |
| Cytologix Corp. v. Ventana Medical | 1:01cv10178 | Zobel | Pending |
| Bicon, Inc., et al v. The Straumann | 1:01cv10269 | O'Toole | Pending |
| Co, et al | | | |
| Pause Technology LLC v. TiVo Inc. | 1:01cv11657 | Saris | Pending |
| Color Kinetics Inc. v. Super Vision | 1:02cv11137 | Lasker | Pending |
| Interna | | | |
| Gyory v. Reebock Int'l, Ltd. | 1:03cv10077 | Young | Pending |
| Teva Pharmaceuticals v. Pfizer, Inc. | 1:03cv10167 | Stearns | Pending |
| Mykrolis Corporation v. Pall | 1:03cv10392 | O'Toole | Pending |
| Corporation | | | |
| Inverness Medical Switzerland GmbH | 1:03cv11323 | Saris | Pending |
| et al v. Acon Labortories, In | | | |
| The Gillette Company v. Energizer | 1:03cv11514 | Saris | Pending |
| Holdings, Inc., | | | |
| L.G. Philips LCD., Co. LTD v. Bovio | 1:04cv11076 | Lindsay | Pending |
| et al | | | |
| Solomon v. Vest et al | 1:04cv12499 | Young | Pending |
| Brine, Inc., et al v. STX, L.L.C., et al | 4:99cv40167 | Gorton | Pending |
| Festo Corp v. Shoketsu Kinzoku, et | 1:88cv01814 | Saris | Remanded |
| al | | | |
| Read Corp., the, et al v. Friday, et al | 1:92cv12085 | Young | Remanded |
| Hologic, Inc. v. Lunar Corporation | 1:94cv11876 | Harrington | Remanded |
| Nova Biomedical Corp v. I-Stat | 1:95cv11396 | Stearns | Remanded |
| Corporation | | | |
| ICN Photonics v. Cynosure Inc | 1:01cv11496 | Stearns | Reversed in part and |
| | | | Remanded |
| State Street Ban & T v. Signature | 1:94cv11344 | Saris | Reversed in part and |
| Financial | | | Remanded |
| Spalding & Evenflo v. Wilson | 3:97cv30275 | Ponsor | Reversed |
| Sporting Good | | | |
| Weiss, et al v. Reebok International | 1:00cv11373 | O'Toole | Vacated in part and |
| | | | Remanded |
| Atlantic Thermoplast v. Faytex Corp | 1:88cv00210 | Harrington | Vacated in part and |
| | | | Remanded |
| Ciba Corning Diagnos v. Alko | 1:91cv10239 | Tauro | Vacated in part and |
| Diagnostic | | | Remanded |
| Stark v. Advanced Magnetics, et al | 1:92cv12157 | Tauro | Vacated in part and |
| | | | Remanded |
| Johansson v. Rose Displays Ltd | 1:95cv11633 | Young | Vacated in part and |
| | | | Remanded |

Of the 957 patent cases (both open and closed) in the District of Massachusetts, at least one of the parties demanded a jury in 66.5% of the cases (636 of 957 cases). Both sides demanded a jury in 16.5% of the cases (158 of 957). The patentee, but not the accused infringer, demanded ajury in 40.4% of the cases (387 of 957). The accused infringer, but not the patentee, demanded ajury in 9.5% of the cases (91 of 957). Neither party demanded a jury in 33.5% of the cases (321 of 957). The chart below illustrates the jury demands in the District of Massachusetts for patent cases over this period.

[image]

The judges in the District of Massachusetts vary considerably in their exposure to patent cases in general and to significant motions in those cases.

There were 60 total patent cases for each active judge (on average). But the actual number of patent cases per judge varies significantly. The table below shows the total number of patent cases and total number of closed patent cases for each of these judges.

| | Number of | Number of |
|---|---|---|
| Judge | Patent Cases | Closed Patent Cases |
| Average for the | 60 | 54 |
| Court | | |
| Gertner | 60 | 53 |
| Gorton | 69 | 66 |
| Harrington | 59 | 53 |
| Keeton | 75 | 70 |
| Lasker | 26 | 24 |
| Lindsay | 60 | 55 |
| O'Toole | 55 | 49 |
| Ponsor | 35 | 29 |
| Saris | 62 | 56 |
| Saylor | 10 | 6 |
| Stearns | 68 | 56 |
| Tauro | 63 | 59 |
| Wolf | 88 | 84 |
| Woodlock | 74 | 64 |
| Young | 85 | 81 |
| Zobel | 68 | 55 |

There was claim construction activity in 165 of these patent cases. These figures do not include cases with summary judgment activity that may involve claim construction issues. The table below shows the number of cases with claim construction activity for each judge.

| Judge | Number of Cases with Claim Construction Activity |
|---|---|
| Gertner | 8 |
| Gorton | 12 |
| Harrington | 8 |
| Keeton | 6 |
| Lasker | 5 |
| Lindsay | 9 |
| O'Toole | 5 |
| Ponsor | 13 |
| Saris | 16 |
| Saylor | 3 |
| Stearns | 14 |
| Tauro | 0 |
| Wolf | 6 |
| Woodlock | 19 |
| Young | 22 |
| Zobel | 19 |

There were 299 patent cases with summary judgment activity (a motion or order relating to summary judgment) in the District of Massachusetts in the period covered by this report. The number of cases with summary judgment activity varied from 3 cases for Judge Saylor to 39 cases for Judge Young. The table below illustrates the variation among the judges in these cases.

| | Number of Cases with |
|---|---|
| Judge | Summary Judgment Activity |
| Average for the Court | 18.7 |
| Gertner | 16 |
| Gorton | 17 |
| Harrington | 17 |
| Keeton | 11 |
| Lasker | 12 |
| Lindsay | 17 |
| O'Toole | 16 |
| Ponsor | 10 |
| Saris | 38 |
| Saylor | 3 |
| Stearns | 24 |
| Tauro | 10 |
| Wolf | 13 |
| Woodlock | 36 |
| Young | 39 |
| Zobel | 20 |

There were 114 patent cases with preliminary injunction activity (a motion or order relating to preliminary injunctions or temporary restraining orders) in the District of Massachusetts in the period covered by this report. The number of cases with preliminary injunction activity varied from 0 cases for Judge Saylor to 14 cases for Judges Woodlock and Young. The table below illustrates the variation among the judges in these cases.

| | Number of Cases with |
|---|---|
| Judge | Preliminary Injunction Activity |
| Average for the Court | 7.1 |
| Gertner | 7 |
| Gorton | 4 |
| Harrington | 5 |
| Keeton | 9 |
| Lasker | 3 |
| Lindsay | 8 |
| O'Toole | 12 |
| Ponsor | 1 |
| Saris | 9 |
| Saylor | 0 |
| Stearns | 4 |
| Tauro | 5 |
| Wolf | 8 |
| Woodlock | 14 |
| Young | 14 |
| Zobel | 11 |

From the above it will be seen that the various objects and features of the present invention are achieved and other advantageous results obtained.

What is claimed is:

1. A method of obtaining litigation significant information concerning litigation in a predetermined venue, comprising:
identifying a group of active judges in a predetermined venue;
classifying at least some outcomes for each active judge in the group for a particular type of case;
aggregating the classified outcomes to obtain composite outcomes for the group.

2. The method as set forth in claim 1 wherein the group includes all the active judges in the predetermined venue.

3. The method as set forth in claim 1 wherein the group consists of the active judges in a division of the predetermined venue.

4. The method as set forth in claim 1 wherein the identifying step occurs before the classifying step.

5. The method as set forth in claim 1 wherein the identifying step occurs after the classifying step.

6. The method as set forth in claim 1 wherein the classifying step includes identifying a prevailing party in the litigation.

7. The method as set forth in claim 1 wherein the classifying step includes identifying the outcome by type.

8. The method as set forth in claim 1 wherein the classifying step includes identifying a terminating event.

9. The method as set forth in claim 1 wherein the classifying step includes examining dockets of litigation of the predetermined type of case.

10. The method as set forth in claim 1 wherein the active judges are identified in part by identifying the judges to which cases of the predetermined type are being assigned.

11. The method as set forth in claim 1 wherein the aggregating step includes a step of summing the classified outcomes.

12. The method as set forth in claim 1 wherein the aggregating step includes a step of averaging the classified outcomes.

13. The method as set forth in claim 1 wherein a venue win rate is determined from the aggregated outcomes.

14. The method as set forth in claim 1 wherein a venue time to decision is determined from the aggregated outcomes.

15. The method as set forth in claim 1 wherein a venue time to decision on the merits is determined from the aggregated outcomes.

16. The method as set forth in claim 1 further including aggregating the outcomes for each judge in the group to obtain aggregated outcomes for each judge; and comparing at least one aggregated outcome for each judge to the corresponding aggregated outcome for the other judges.

17. The method as set forth in claim 16 wherein said one aggregated outcome is a win rate.

18. The method as set forth in claim 16 wherein said one aggregated outcome is a pendency.

19. The method as set forth in claim 16 wherein said one aggregated outcome is a time to decision on the merits.

20. A method of comparing active judges in a predetermined venue, comprising the steps of:
determining time from filing to final judgment on the merits for each of a group of active judges in a predetermined venue;
comparing the time from filing to final judgment on the merits for each judge in the group.

21. A method of comparing active judges, comprising the steps of:
measuring an experience level of each active judge in a group of active judges in a predetermined type of case;
comparing the measured experience level for each active judge in the group.

22. The method as set forth in claim 21 wherein the experience levels are measured, at least in part, by counting the number of cases of the predetermined type for each active judge in the group.

23. The method as set forth in claim 21 wherein the experience levels are measured, at least in part, by determining the number of cases in which predetermined activity occurred for each active judge in the group.

24. The method as set forth in claim 23 wherein the predetermined activity includes the filing of a summary judgment motion.

25. The method as set forth in claim 23 wherein the predetermined activity includes the filing of a preliminary injunction motion.

26. A method of comparing active judges, comprising the steps of:
identifying a group of active judges;
identifying decisions of a predetermined type of non-dispositive motion for each active judge in the group;
aggregating said decisions to obtain aggregated decision information for each active judge in the group;
comparing the aggregated decision information for each active judge to the aggregated decision information of the other active judges in the group.

27. A method of obtaining litigation significant information for a predetermined venue, comprising the steps of:
identifying decisions on preliminary injunction motions for a group of active judges in a predetermined venue;
identifying said decisions that were appealed;
determining results of appeals of said appealed decisions;
aggregating the results of said appeals.

28. The method as set forth in claim 27 wherein the aggregating step includes determining the number of appealed decisions that were affirmed.

29. The method as set forth in claim 27 wherein the aggregating step includes determining the number of appealed decisions that were affirmed at least in part.

30. The method as set forth in claim 27 wherein the aggregating step includes determining the number of appealed decisions that were reversed.

31. The method as set forth in claim 27 wherein the aggregating step includes determining the number of appealed decisions that were reversed at least in part.

32. A method of comparing two different venues, comprising the steps of:
identifying a group of active judges in a first venue;
identifying a group of active judges in a second venue;
classifying at least some outcomes for each active judge in each group for a particular type of case;
aggregating the outcomes for each district;
comparing the aggregated outcomes for each district.
